(19) United States
(12) Patent Application Publication
(10) Pub. No.: US 2006/0047558 A1
(43) Pub. Date: Mar. 2, 2006

(54) Method, system, and computer program product for assigning personnel to project tasks

(76) Inventors: Norimasa Uchiyama, Yamato-shi (JP); Hitomi Abe, Yamato-shi (JP); Junichi Banno, Sagamihara-shi (JP)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/185,470

(22) Filed: Jul. 20, 2005

(30) Foreign Application Priority Data
Aug. 31, 2004 (JP) 2004-253269

(51) Int. Cl. G06F 15/02

(52) U.S. Cl. 705/9

(57) ABSTRACT

A personnel assignment system is connected to a project management system and a personnel management system The project management system retains information on tasks to which personnel have already been assigned as task data. Task data is associated with identification data of the assigned personnel. The identification data, which is also included in the personnel management system, is used as record retrieval keys. The personnel assignment system automatically extracts related assigned tasks from the identification data when changes occur in the personnel data, and automatically executes reassignment of replacements.

### FIELD OF THE INVENTION

The present invention relates to systems for assigning personnel to projects, and in particular to a system and a method wherein personnel reassignments can be performed dynamically when personnel data are changed following a personnel assignment.

### BACKGROUND

In the field of project management, several techniques have been proposed for the optimal assignment of personnel to a project. For example, a “personnel supply optimization method” is disclosed in Japanese patent document JP-A-2003-44642, and a “resource management server, a personnel management method and a personnel management system” are disclosed in Japanese patent document JP-A-2004-118648.

According to the system and the method disclosed in JP-A-2003-44642, personnel having a required skill are not only selected from a specific department in a company, but from all departments, and are assigned to a target project. For this system, personnel data that can be assigned to a project are registered in advance as personnel files, skill files, and project management capability files. In a first embodiment described in this publication, a method is disclosed wherein, in response to a personnel search request, the names of available personnel are located and extracted. In a second embodiment, a method is disclosed wherein data for registered personnel are compared with the contents of a search request to determine whether specific, appropriate personnel are available for assignment to a project. For either method, personnel data are assumed to be previously registered fixed data. Following the designation of the requirements for a project, a data search process can be performed to match personnel with the project.

According to the resource management system and method disclosed in JP-A-2004-118648, information related to personnel (a personnel database) and information related to skills (a knowledge database) are linked with a project management tool to enable the effective utilization of individual capabilities. Also for this system, data (to include personnel information and skill information) for personnel available for assignment to a project are stored in a database in advance, and when the requirements for a project are entered, a search can be initiated for appropriate individuals. Subsequently, the user requesting the search may select a candidate, or candidates, from a list prepared during the search, and can thus complete the assignment of personnel to the project.

When a person who manages a project (a project manager) enters the requirements for the project, such as the relevant tasks and skills and periods required for the individual tasks, the conventional personnel assignment systems described above search for pre-registered personnel data, and automatically assign individuals who have skills satisfying the search conditions. The personnel data are stored locally, in advance, or data stored in another system are periodically copied as a replica.

However, for these conventional personnel assignment systems, no consideration is given to a mechanism that dynamically reviews the assignment of personnel to a project. For example, a situation where an individual assigned to a project suddenly departs on leave cannot be handled flexibly by the conventional techniques.

When the requirements for a project are changed, personnel assignments may be revised merely by repeating the personnel assignment process. However, if personnel data are changed following the completion of an assignment process, e.g., if assigned individuals retire or depart on leave, or if the skill requirements are altered, generally a project manager will not automatically be cognizant of this. Further, even when a project manager is aware of a change in an individual's personnel data, he or she must determine which project or individual task the pertinent person is assigned to, and must again request the execution of the personnel assignment process for the related project or task that should be changed. As a result, the load imposed on the project manager is increased, and the progress of the project is adversely affected.

To avoid the occurrence of the above problem, fixed data that cannot be changed may be employed as the personnel data. However, since from the viewpoint of a person such as a resource manager who is responsible for managing the personnel data, such a system is inflexible and impractical, and since from the viewpoint of a project manager, project management based on the latest personnel data is disabled, the use of fixed personnel data is very inconvenient.

Therefore, it is preferable that a personnel assignment system be operable independently of a personnel management system provided for managing personnel data and a project management system for managing project management data, and that the personnel assignment system flexibly and dynamically cope with both project management and personnel management by fully employing the latest data provided by the two systems.

One objective of the present invention is to provide a mechanism whereby, even when the conditions governing the assignment of individuals to a project change, the individuals can be dynamically reassigned in accordance with pertinent personnel data changes. Another objective of the present invention is to reduce the project management load and the personnel management load arising from changes in the personnel data. A further objective of the present invention is to immediately notify a project manager or a resource manager of changes in personnel data, so as to enable appropriate and efficient project management. Yet another objective of the present invention is to provide a system, synchronized with a project management system and a personnel management system, for flexibly assigning personnel to projects.

### SUMMARY

A personnel assignment method according to the present invention may be installed in a computer (a personnel assignment system) connected to a first system (a project management system), for managing data (task data) related to a plurality of tasks constituting a project, and a second system (a personnel management system), for managing personnel related data (personnel data), including identification data.

Information related to tasks allocated for assigned personnel is stored as task data in the first system (the project management system), and for the assigned personnel, identification data, at the least, are correlated with the task data. Since the identification data are also included in personnel data stored in the second system (the personnel management system), the identification data can be employed as key information for a record search.

When a resource manager or another authorized person such as a personnel manager, an assigned individual, or a chief who receives a personnel report, changes specific personnel data stored in the second system (the personnel management system), the personnel assignment system accepts the entered data. In accordance with a change in the personnel data, the personnel assignment system examines task data stored in the first system (the project management system) by employing the identification data as a search key, and determines whether there is a relevant task assigned to the individual that should be changed. When there is at least one relevant task, the personnel assignment system obtains the task data for the relevant task and stores the task data in an event database (a personnel event database).

Data (event data) in the event database can be displayed on the display device of the resource manager or the project manager. According to an embodiment of the present invention, the resource manager assigns personnel, and, thereafter, the project manager approves or disapproves the assignment contents. Therefore, the event data may be presented first on the user terminal of the resource manager. However, it should be noted that this is neither a necessary condition nor a limitation of the invention.

When the personnel assignment system receives a search request for an individual replacement to perform a relevant task displayed on a terminal, the personnel assignment system examines the second system (the personnel management system) to find replacement candidates eligible for assignment to the relevant task, and obtains the personnel data for the replacement candidates. The list of the replacement candidates who can be so assigned is also displayed on the display device of the resource manager or the project manager. When the personnel assignment system accepts a replacement candidate selected from the list, the personnel assignment system assigns the selected individual to the relevant task and stores the corresponding personnel data in the event database. When the project manager approves the assignment of the replacement, the personnel assignment system of this invention stores the identification data for the assigned individual in the first system (the project management system), in correlation with the task data for the relevant task. As a result, the reassignment data can be automatically reflected in the project management system.

Before designating a replacement candidate who can be reassigned, it is important to determine whether a task has already been assigned to the candidate. This is necessary because it is not practical for a candidate to be allocated a new task for a period that overlaps the period for a task that has already been assigned. In order to avoid such a situation, the personnel assignment system of the invention examines not only the personnel data stored in the second system (the personnel management system), but also the task data in the first system (the project management system) to find replacement candidates. Therefore, only those replacement candidates for whom the period data for a new task and the period data for an assigned task do not overlap are included in the replacement candidate list.

The present invention can be provided as a computer for performing the above described personnel assignment operation, a method therefor, or a program that enables a computer to perform such a method.

As is described above, the present invention can provide a mechanism that, when the situation for personnel assigned to a project is changed, the personnel can be reassigned dynamically, in accordance with the change. Through this mechanism, the project management load and the personnel management load required to deal with a change in the personnel data can be reduced. Furthermore, when the personnel data are changed, this can immediately be identified by the project manager or the resource manager. Appropriate and efficient project management result.

The system of the present invention may operate independently of a conventional project management system and a conventional personnel management system, while actively supporting the functions of the two systems. Therefore, by appropriately providing synchronization with the latest data stored in these systems, a flexible and dynamic personnel assignment process can be performed.

### BRIEF DESCRIPTION OF THE DRAWINGS

The invention may be best understood by reading the detailed description below, taken together with the drawings, wherein:

FIG. 1 is a diagram showing the configuration of a general system appropriate for a personnel assignment method according to the present invention.

FIG. 2 is a diagram showing exemplary task data stored in a project management database.

FIG. 3 is a diagram showing exemplary personnel data stored in a personnel management database.

FIG. 4 is a diagram showing exemplary event data stored in a task event database.

FIG. 5 is a diagram showing exemplary event data stored in a personnel event database.

FIG. 6 is a functional block diagram that shows personnel assignment system.

FIG. 7 is a flowchart that shows processing performed by the personnel assignment system when a task requirement event has occurred.

FIG. 8 is a flowchart that shows processing performed by the personnel assignment system when a personnel requirement event has occurred.

FIG. 9 is a diagram showing an exemplary image for the screen of a project management system for the entry of task requirements.

FIG. 10 is a diagram showing an exemplary screen image when a resource manager accesses the personal assignment system.

FIG. 11 is a diagram showing an exemplary screen image when the project manager accesses the personnel assignment system.

FIG. 12 is a diagram showing an exemplary screen image for a project management system after a personnel assignment has been approved.

FIG. 13 is a diagram showing an exemplary screen image for a personnel management system for the entry of personnel requirements.

FIG. 14 is a diagram showing an exemplary screen image when the resource manager accesses the personnel assignment system.

FIG. 15 is a diagram showing an exemplary screen image when the project manager accesses the personnel assignment system.

FIG. 16 is a diagram showing an exemplary screen image for the project management system after the personnel assignment has been approved.

### DETAILED DESCRIPTION

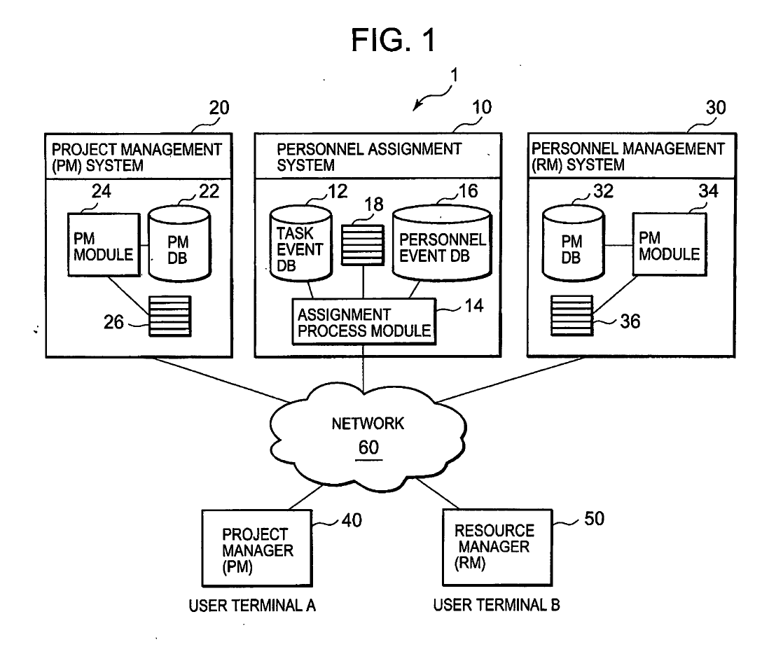

FIG. 1 is a diagram showing the configuration of a general system 1 that is suitable for performing a personnel assignment method according to one embodiment of the present invention. As is shown in FIG. 1, the general system 1 comprises a personnel assignment system 10, a project management system (a PM system) 20 and a personnel management system (an RM system) 30. These systems may be provided using computers such as common servers. A user terminal 40 of a project manager (PM) and a user terminal 50 of a resource manager (RM) may be connected to the general system 1 via a network 60. However, the project manager and the resource manager may operate the PM system 20 and the RM system 30 directly.

The personnel assignment system 10 may be a computer, such as a server, that performs the essential function of the invention for assigning personnel to tasks constituting a project, and may be connected to the PM system 20 and the RM system 30 via the network 60. The personnel assignment system 10 can be accessed by the project manager (PM) and the resource manager (RM); however, the range of the accessible data may be limited. The personnel assignment system 10 may include a task event database (a task event DB) 12, an assignment process module 14, a personnel event database (a personnel event DB) 16, and a candidate table 18. The configuration and the operation will be described in more detail later.

The PM system 20 may be a computer such as a server that holds and manages information related to projects, and may be employed mainly by a project manager. The PM system 20 can be obtained by introducing a project management tool available on the market to a computer, and includes a project management database (a PM-DB) 22, a project management module (a PM module) 24, and an event table 26.

The project manager may access the PM system 20 via the user terminal 40. The PM module 24 generates a screen for entering the requirements for a project for which personnel assignment is required, and displays the screen on the user terminal 40. One project generally includes a plurality of tasks. For example, a product development project may include a design task, a development task, and a test task. For the individual tasks of the project, the project manager enters data for the project requirements, such as the number of persons and the required skills and skill levels, and the task execution periods. The data entered are stored in the project management database 22 by the PM module 24. When the project manager has entered data for all the project requirements and enters a request for personnel assignment, the request is written as event data to the event table 26.

Here, a “task requirement event” or a “task event” is an event wherein the requirements for the tasks constituting a project are entered and the requested personnel are assigned. The “task requirement event” may include establishing and changing the task contents, including the requested skills and periods, and the addition and deletion of tasks.

In this exemplary embodiment, the personnel assignment system 10 performs a periodic polling of the event table 26. Therefore, when the task requirement event is written to the event table 26, this event is accepted by the personnel assignment system 10. Of course, each time a task requirement event occurs, a personnel assignment request may be transmitted to the personnel assignment system 10.

The RM system 30 may be a computer such as a server that holds and manages information related to assigned personnel, and may typically be used by the resource manager. The RM system 30 can be obtained by loading into the computer a personnel management tool available on the market, and includes a personnel management database (RM-DB) 32, a personnel management module (RM module) 34, and an event table 36.

The resource manager accesses the RM system 30 via the user terminal 50. In accordance with a request from the resource manager, the RM module 34 extracts required personnel data from the personnel management database 32, generates a screen, and transmits the screen to the user terminal 50. The resource manager can perform an editing operation on the screen, such as creating, changing, or deleting personnel data. An authorized person (e.g., a person in charge in a personnel department, an assigned person, or a chief of the person who submits a report), other than the resource manager, can also refer to or edit the personnel data. When the resource manager again issues a request for personnel assignment in response to editing of the personnel data, the request may be written in the event table 36 as event data.

Here, a “personnel requirement event” or a “personnel event” is an event during which a personnel assignment is again requested, in accordance with a change in the personnel data. A “personnel requirement event” may include establishing and changing assigned personnel, deleting or adding a person, and updating the skills and status of the personnel.

In this exemplary embodiment, the personnel assignment system 10 polls the event table 36 periodically. When a personnel requirement event is written to the event table 36, this event is accepted by the personnel assignment system 10. Of course, each time a personnel requirement event occurs, a personnel assignment request may be transmitted to the personnel assignment system 10.

The user terminals 40 and 50 may be common information apparatus such as personal computers, PDAs (portable information terminals), or cellular phones. Users such as project managers and resource managers need only employ a general web browser via the user terminals 40 and 50, or execute a special client program to access the general system 1. The network 60 may be either a closed network, such as an in-house LAN, or an open network, such as the Internet. However, to provide improved security, it is preferable that a mechanism be provided that permits only authorized users to access the system.

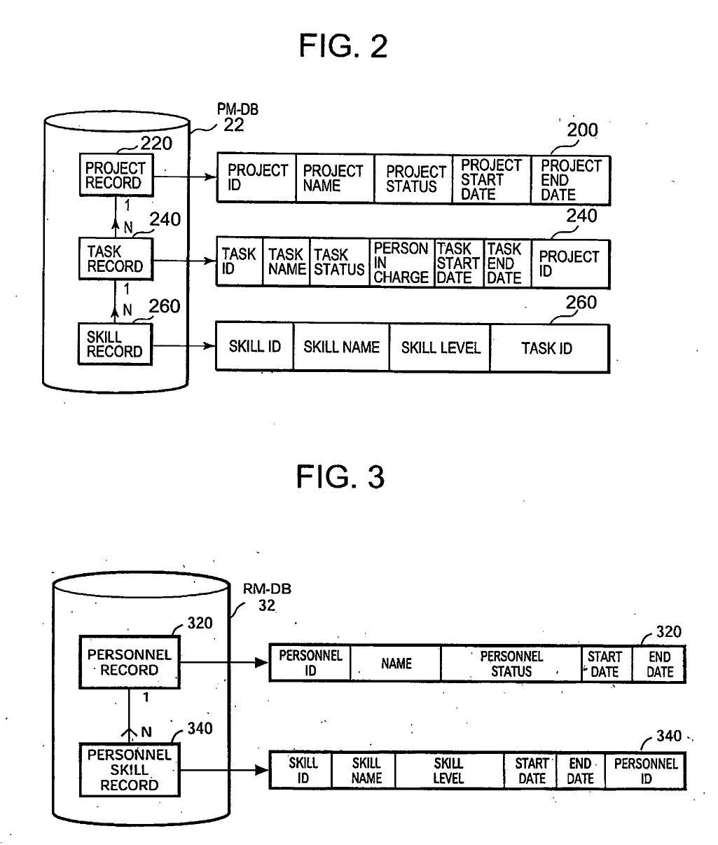

Various types of exemplary data used by the general system 1 will now be explained, with reference to FIGS. 2 to 5. It should be noted, however, that these examples are give only for the purpose of illustration, and that other data items may be included in an actual system.

FIG. 2 is a diagram showing exemplary task data stored in the project management database 22 of the PM system 20. A project record 220, task records 240, and skill records 260 are stored in the project management database 22. These task data are typically entered by the project manager who designates the project requirements.

The project record 220 includes information required for specifying each project, and, in this example, includes the following fields: a “project ID” field that includes a number for identifying a specific project, wherein one number is allocated for one project; a “project name” field that includes the name of a project; and a “project status” field that includes data representing the current status of each project, such as “CREATE (project data being currently created)”, “ASSIGNED (personnel already assigned)”, “ACTIVE (project being started and currently executed)”, “REVIEW (project being currently reviewed)”, “COMPLETE (project completed)” and “ARCHIVE (data stored)”. A “project start date” field contains data for the date when a pertinent project was started, and a “project end date” field contains data for the date when all the tasks were completed and the project was ended.

The task records 240 include information for specifying individual tasks. As previously described, since one project is constituted by a plurality of tasks, a “1:N” relation is established between the project record 220 and the task records 240. Each of the task records 240 may include the following data fields: a “task ID” field that includes a number for identifying a specific task, with one number allocated for one task; a “task name” field that includes the name of a pertinent task; and a “task status” field that includes data representing the current status of each task, such as “CREATE (task data being currently created)”, “ASSIGNED (personnel already assigned)”, “ACTIVE (task being started and currently executed)”, “REVIEW (task being reviewed)” and “COMPLETE (task completed)”. An “in charge” field may include data for specifying a person assigned to a pertinent task. A “task start date” field may include the date when a task was started. A “task end date” field may include the date when a task was ended. A “project ID” field may include an identification number for a corresponding project; by using this data as an external key, the task records 240 can be correlated with the corresponding project records 220.

The skill record 260 includes information related to skills required to execute a task. Since a plurality of skills may be required to execute a single task, a “1:N” relation is established between one task record 240 and the skill records 260. Each of the skill records 260 may include the following fields: a “skill ID” field, which includes a number used to identify a specific skill; a “skill name” field, which represents the name of a skill, and may include, for example, data for a project manager (role), a designer (role), a tester (role), English (a language) and JAVA (R) (a programming language); a “skill level” field, which may include a relative evaluation for each skill, represented by a numerical value (in this embodiment, the numerical values 0 to 9 can be entered); and a “task ID” field, which may include an identification number for a corresponding task for use as an external key to correlate the skill records 260 with the corresponding task record 240.

FIG. 3 is a diagram showing exemplary personnel data stored in the personnel management database 32 of the RM system 30. Here, a personnel record 320 and personnel skill records 340 may be stored in the personnel management database 32. These personnel data can be entered by, for example, a resource manager, or personnel manager.

The personnel record 320 includes information for specifying a person managed by the RM system 30, such as: a “personnel ID” field, which carries a number for identifying an individual person; a “name” field that includes the name of the person; a “start date” field that represents the starting date of an effective period for the data in the “personnel status” field; an “end date” field for the ending date of the effective period for the data in the “personnel status” field; and a “personnel status” field that represents data indicating the current status of each person, such as “AVAILABLE (on duty)”, “VACATION (on vacation)” and “LEAVE (on leave)”. In this embodiment, since the RM system 30 is not a specialized system for personnel assignment, a special status such as “ASSIGNED (already assigned)” is not prepared; however, inherent status data may be prepared for personnel assignment.

The personnel skill record 340 may include information for the skills of individuals, and may have a data structure similar to the skill record 260. Since one person may have a plurality of skills, a “1:N” relation is established between one personnel record 320 and the personnel skill records 340. Each of the personnel skill records 340 may include the following data fields: a “skill ID” field, which includes a number for identifying a specific skill; a “skill name” field, which represent the name of a skill, such as data for a project manager (role), a designer (role), a tester (role), English (a language) or JAVA (R) (a programming language); a “skill level” field, which includes the relative evaluation of each skill is represented by a numerical value (in this embodiment, a range of 0 to 9 can be entered as the numerical value); a “start date” field, which represents the date when the pertinent skill rating became effective; an “end date” field represents the date until which the skill rating is effective; a “person ID” field, which is the identification number for a person having the skill, and which may be used as an external key for correlating the personnel skill records 340 with the corresponding personnel record 320.

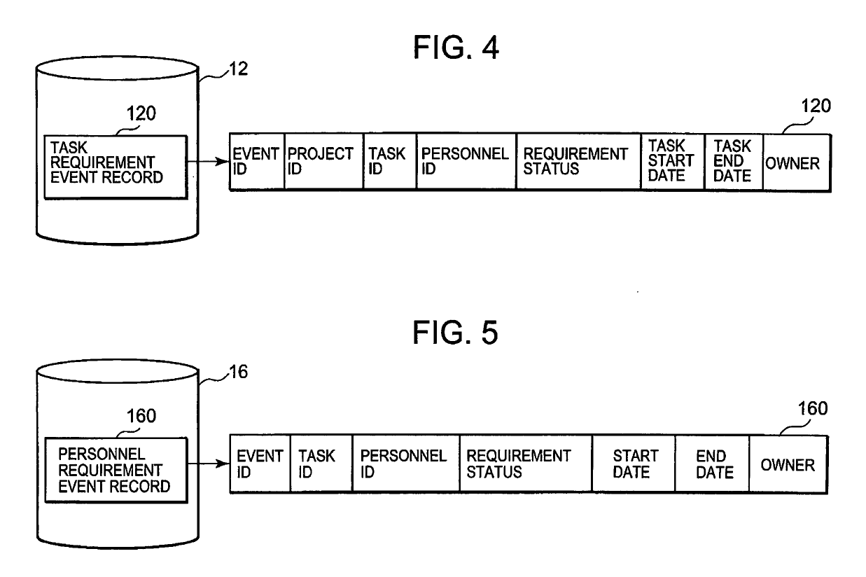

FIG. 4 is a diagram showing exemplary event data stored in the task event database 12 of the personnel assignment system 10. The task requirement event data can be represented as a set of task requirement records 120. When the personnel assignment system 10 receives a task requirement event, for each task, a task requirement record 120 is generated that is deleted, or stored as log data (non-active), when the processing has been completed. The task requirement record 120 holds information concerning which persons are to be assigned to which tasks for how long, and may include the following data fields: an “event ID” field, which is a number used to identify a task requirement event, and a “project ID” field and a “task ID” field, which include numbers used to identify a related project and a related task. By using the data in the “project ID” field, the task requirement record 120 can be correlated with the project record 220 in the project management database 22. Since a plurality of tasks are present for one project, a “1:N” relation is established between the task requirement records 120 and one project record 220. The project record 220 is described above.

A “personnel ID” field is a number used to identify a person assigned to a task. A “requirement status” field includes data representing the current status of each task, such as “REQUESTED (request accepted)”, “ASSIGNED (personnel assigned)”, “NOT ASSIGNED (no personnel assigned yet)”, “NOT AVAILABLE (personnel assignment disabled)”, “APPROVED (approved)” and “REJECTED (reassignment requested)”. A “task start date” field includes data for a date to start a task, and a “task end date” field includes data for a date at which to end the task. And an “owner” field represents a user who can access the task requirement record 120. In this embodiment, since a project manager or a resource manager is the main user, the type of user or identification information for a user is written, e.g., 0 or 1 of a corresponding data bit is changed. That is, when the data in the “owner” field are rewritten, access by the user can be controlled.

FIG. 5 is a diagram showing exemplary event data stored in the personnel event database 16 of the personnel assignment system 10. The personnel requirement event data can be represented as a set of personnel requirement records 160. When an event occurs, a personnel requirement record 160 is generated that is deleted, or is stored as log data (non-active), when the processing has been completed. When data for personnel who have already been assigned to a project (specifically, to the tasks) are changed, the personnel requirement record 160 is generated for a task assigned to pertinent personnel, i.e., a task that is affected by changes in the personnel data. Changes in the personnel data include the deletion of personnel, and status and skill level changes. The changing of the personnel data entries is permitted not only by the resource manager, but also, for example, by the personnel manager, and by other authorized persons. The personnel requirement record 160 holds information for an identification number for a task, the status, and the period, and may have the following data fields: an “event ID” field, which is a number used to identify a personnel requirement event; a “task ID” field, which is a number used to identify a related task assigned to a pertinent person; and a “personnel ID” field, which is a number used to identify a person for whom the personnel data are changed. By using the data in the “personnel ID” field, the personnel requirement records 160 can be are correlated with the personnel record 320 in the personnel management database 32. Since a plurality of tasks may be assigned to one person, an “N:1” relation is established between the personnel requirement records 160 and one personnel record 320. Since the personnel record 320 has already been explained, no detailed explanation for it will be given.

A “requirement status” field includes data representing the current status of each person, such as “REQUESTED (request accepted)”, “ASSIGNED (personnel assigned)”, “NOT ASSIGNED (no personnel assigned yet)”, “NOT AVAILABLE (personnel assignment disabled)”, “APPROVED (approved)” and “REJECTED (reassignment requested)”. A “start date” field and an “end date” field specify the starting point and the ending point of a period during which the personnel requirement is effective. An “owner” field represents a user who can access the personnel requirement record 160. In this embodiment, since the project manager or the resource manager is the main user, the type of user or the identification information for the user is written, e.g., a corresponding data bit is switched between 0 and 1. That is, by rewriting the data in the “owner” field, access by the user can be controlled.

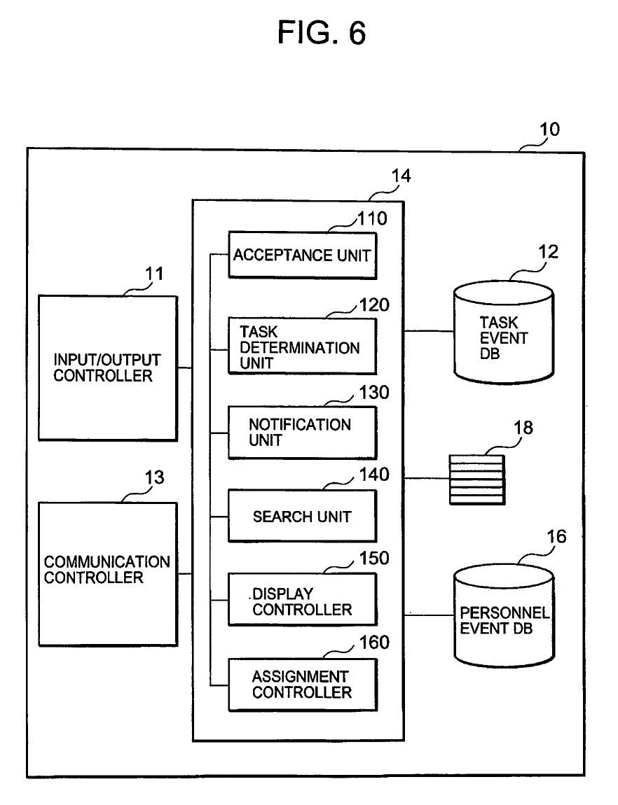

FIG. 6 is a functional block diagram showing the personnel assignment system 10. The personnel assignment system 10 comprises an input/output controller 11, the task event database (task event DB) 12, a communication controller 13, an assignment process module 14, the personnel event database (personnel event DB) 16 and a candidate table 18. Since the task event DB 12 and the personnel event DB 16 have been explained while referring to FIGS. 4 and 5, no detailed explanation for them will be given.

The input/output controller 11 is an interface between the assignment process module 14 and an input device, such as a keyboard or a mouse, an output device, such as a display device or a printer, an external storage device, such as a CD-ROM or a hard disk drive, and another input/output device. When, for example, the project manager or the resource manager directly operates the personnel assignment system 10, the input/output controller 11 handles the input/output of data.

The communication controller 13 is an interface between an external network and the assignment process module 14. In this embodiment, the communication controller 13 controls the exchange of data with the user terminal 40 of the project manager or with the user terminal 50 of the resource manager via the network 60.

The assignment process module 14 is a program that, when a task requirement event and a personnel requirement event have occurred, performs a series of processes for assigning appropriate persons. Physically, the program stored in a storage device, such as the hard disk, of the personnel assignment system 10 is read and executed by a processor (CPU), so that various types of functions can be performed. The assignment process module 14 includes an acceptance unit 110, a task determination unit 120, a notification unit 130, a search unit 140, a display controller 150 and an assignment controller 160.

The acceptance unit 110 accepts requests, designations and other entries from the project manager or from the resource manager. Specifically, the acceptance unit 110 accepts a personnel assignment requests (task requirement events) consonant with the input of task requirements, changes in personnel data (personnel requirement events) consonant with the input of personnel requirements, personnel search requests and the editing, selection, confirmation or rejection of displayed records, and assignment approvals.

Upon the occurrence of a personnel requirement event, the task determination unit 120 specifies a person for whom data has been changed, and determines whether the person has an assigned task. Specifically, for this determination, the task determination unit 120 issues an inquiry to the PM system 20 using the personnel ID as a key, and determines whether a related task record 240 is stored in the project management database 22.

The notification unit 130 notifies the project manager or the resource manager of that an event has occurred for which some action should be taken. Specifically, when the project manager, or the resource manager, accesses the personnel assignment system 10, the notification unit 130 examines data in the “owner” fields of the task requirement record 120 and the personnel requirement record 160, and when accessible event data are found, presents the event data to the project manager or the resource manager.

Thereafter, the search unit 140 accesses the PM system 20 or the RM system 30 in response to a search request, and obtains information related to a required person or a required task. For example, in response to a personnel search request issued by the resource manager, the search unit 140 searches the personnel management database 32 of the RM system 30 and extracts personnel data for candidates who satisfy task requirements. Further, when the personnel requirement event occurs, in response to a request that a search be conducted for replacement candidates, the search unit 140 also searches the project management database 22 of the PM system 20 and obtains necessary task data. This is done because, when a task has already been assigned to a person who is considered to be a replacement candidate, a new task cannot be assigned to that person during the execution period for the task, and thus, information concerning the assigned task must be obtained. Specifically, the search unit 140 examines period data included in the related task data for the name of a replacement candidate obtained as a result of the search, and when the execution period for a previously assigned related task does not overlap the execution period for the task that is to be reassigned, the name of the pertinent candidate is stored in the candidate table 18, which will be described later. In this manner, a list that includes only those persons that the task can be assigned to is prepared and displayed by the display controller 150.

In this embodiment, the PM system 20 and the RM system 30 function as independent systems, and the operation of the personnel assignment system 10 is performed by combining these two systems. Therefore, the PM system 20 and the RM system 30 can hold the latest data without being aware of the personnel assignment system 10. On the other hand, the personnel assignment system 10 can obtain required data from the PM system 20 or the RM system 30 as necessary. Data for tasks that have already been assigned to the candidates on the list are also obtained, as needed, from the project management database 22.

The list of the persons available for assignment (candidates) that are extracted as a result of the search performed by the search unit 140 is stored in the candidate table 18. The list data are then presented to the project manager, or to the resource manager, and are held until selected candidates are confirmed or rejected, and the assignment (or reassignment) of a person or persons to the task has finally been approved.

The display controller 150 displays the contents of an event that has occurred, the search results (a list of candidates available for assignment) and the assignment results on the user terminal 40 of the project manager or on the user terminal 50 of the resource manager. For the preparation of the display contents, data stored in the task event database 12, the personnel event database 16, the candidate table 18, the PM database 22 and the RM database 32 are referred to as needed.

When the task requirement event or the personnel requirement event has been accepted, the assignment controller 160 creates the event record 120 or 160, and manages it in the event database 12 or 16. Furthermore, when the resource manager performs a user operation, such as the entry, selection, or confirmation of data, or the project manager performs a user operation, such as the entry, selection, confirmation, or approval of data, the assignment controller 160 effects the assignment of an appropriate person to a task. Then, the assignment controller 160 writes, in the project management database 22 of the PM system 20, the contents of the personnel assignment that has been approved by the project manager.

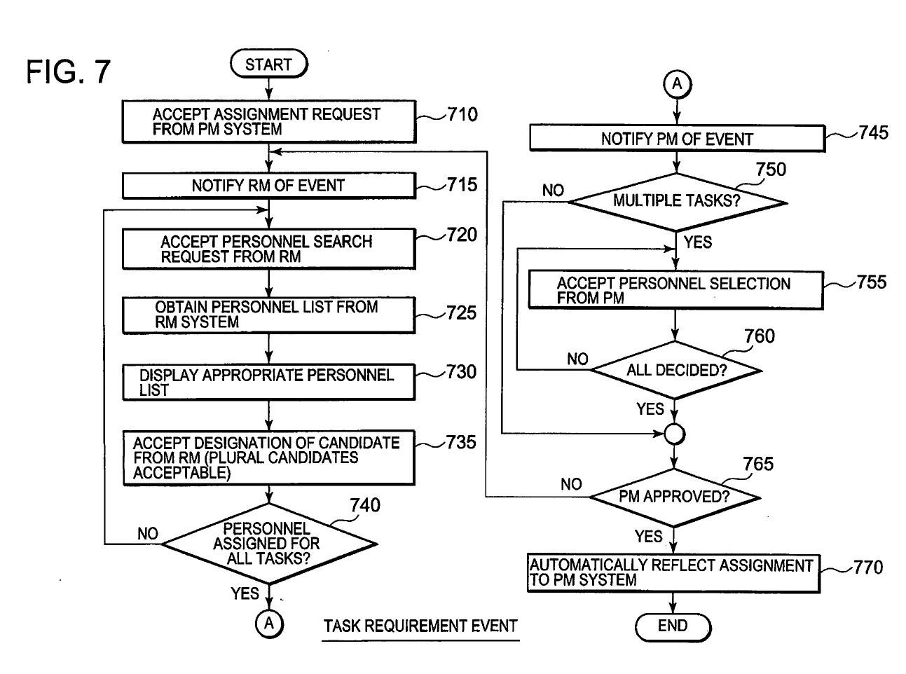

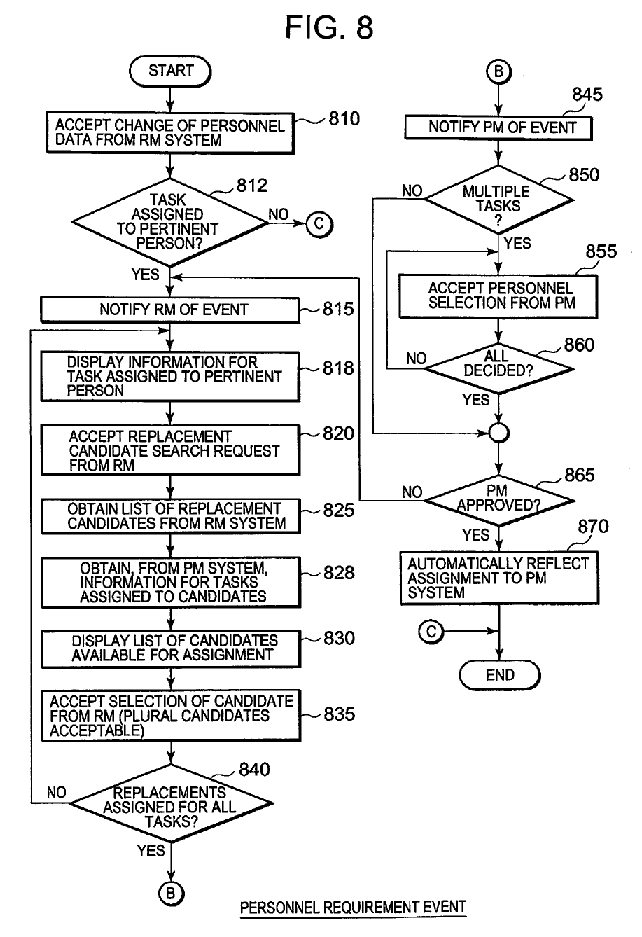

The processing performed by the personnel assignment system 10 in this embodiment will now be explained with the help of an example. More specifically, the processing performed when a task requirement event has occurred will be explained with reference to FIG. 7, and the processing performed when a personnel requirement event has occurred will be explained with reference to FIG. 8. It should be noted that the processing in FIG. 8 may be performed after the personnel assignment processing in FIG. 7 has been completed.

FIG. 7 is a flowchart showing the processing performed by the personnel assignment system 10 when a task requirement event has occurred. This processing will be described with reference to FIGS. 7 and 9 to 12.

In the personnel assignment system 10, the acceptance unit 110 receives, from the PM system 20, a request for the assignment of persons to a task or to a plurality of tasks constituting a project (step 710). This assignment request is generated when a project manager accesses the PM system 20 and enters task requirements.

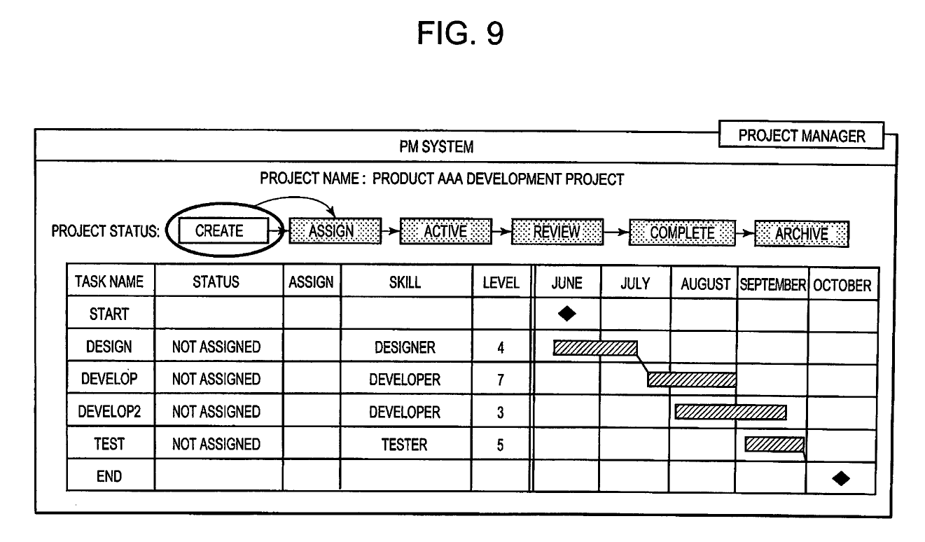

FIG. 9 is a diagram showing an exemplary image of the screen of the PM system 20 for the entry of task requirements. In this example, it is assumed that persons are to be assigned to a development project for product AAA. This project has four tasks: “Design”, “Develop”, “Develop2” and “Test.” The entry of data related to the contents and the required skill levels and the execution periods for these tasks are requested. When these data have been entered and an “ASSIGN” button, for example, is clicked on, an assignment request is generated and written to the event table 26. The personnel assignment system 10 (acceptance unit 110) performs periodical polling for the event table 26, and accepts the assignment request. In response to the acceptance of the assignment request, the assignment controller 160 creates the task requirement event records 120 for the individual tasks, and obtains necessary data from the project management database 22. At this time, data is written to the “owner field” to permit the resource manager to access the personnel assignment system 10. When the resource manager accesses the personnel assignment system 10, the notification unit 130 notifies the resource manager that the event is present (step 715).

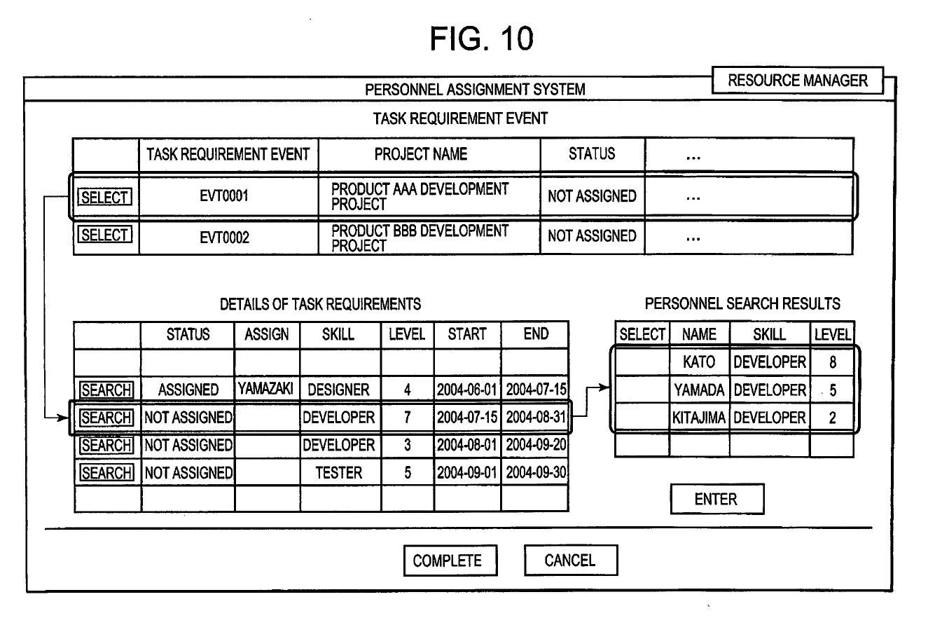

FIG. 10 is a diagram showing an exemplary image for a screen when the resource manager has accessed the personnel assignment system 10. On this screen, two task requirement events (EVTO001 and EVTO002) are present. When the resource manager clicks on the “select” button for “EVTO001”, a table related to the details for corresponding task requirements is shown. In this example, four task requirements are present. When the resource manager clicks on the “search” button for a specific task (developer skill: 7), the acceptance unit 110 accepts a request to perform a search for a person who is available for assignment (step 720).

Upon receiving the search request, the search unit 140 searches the personnel management database 32 of the RM system 30 and obtains data for a person who matches the search conditions (step 725). Specifically, the search unit 140 compares the data in the personnel skill record 340 with the contents and the level of the skill and the execution period for the task that are included in the search conditions, and designates a person who completely or nearly satisfies the search conditions. When a person who completely satisfies the search condition is not found, the permissible range for determining whether a person is “available for assignment” is arbitrarily designated. When the “status” data in the personnel record 320 has been confirmed, personnel data, such as the ID, the name, and the skill level of an available person are also obtained. When the results indicate that a plurality of persons are available for the assignment, a list comprising a plurality of sets of personnel data is obtained.

The display controller 150 displays on the screen a table for the data obtained for the available persons (step 730). In FIG. 10, example search results show that three persons have been selected as candidates. The resource manager enters a check mark in the “select” column to select a desired person on the list. A plurality of persons can also be selected as candidates to be assigned. In this example, however, since a skill level “7” is required, it is most appropriate that “Kato”, who has the highest skill level, be selected. When the resource manager selects a specific person, Kato, for example, and clicks on the “enter” button, the acceptance unit 110 of the personnel assignment system 10 accepts the selection of the candidate (step 735). Then, after the selection of the person to be assigned has been established, the “Status” data in the detail table for task requirements is changed from “NotAssigned” to “Assigned”. See the task record “Designer” to which “Yamazaki” is assigned.

When there are still tasks remaining to which personnel should be assigned (No at step 740), the assignment controller 160 waits for the resource manager to issue another search request (the personnel assignment system 10 is waiting). When the resource manager has assigned personnel to all the tasks and clicks on the “complete” button in the lower portion of the screen (Yes at step 740), the notification unit 130 notifies the project manager of that the assignment of personnel to the project or to the tasks has been completed (step 745).

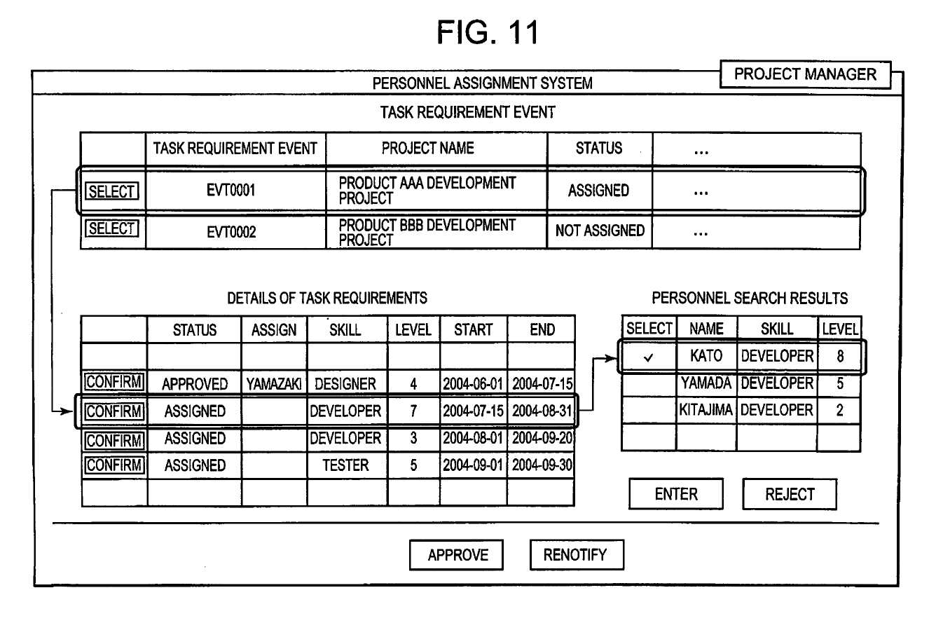

FIG. 11 is a diagram showing an exemplary image for the screen when the project manager accesses the personnel assignment system 10. As is apparent from FIG. 11, the structure of the screen is similar to that in FIG. 10; a detail table, for example, for task requirements is also shown by selecting a specific task. The principal difference between this screen and the screen in FIG. 10 is that the search for candidates for assignment (and for temporary personnel assignment) has already been completed. Therefore, since the project manager need not issue a search request, instead of the “search” button, a “confirm” button, for example, is prepared in the leftmost column of the detail table. When the project manager clicks on the “confirm” button, a list of persons assigned to corresponding tasks is displayed. When the list has a plurality of tasks (Yes at step 750), the project manager may confirm and establish personnel assignments for all the tasks (No at step 760).

When a plurality of candidates are to be assigned, the project manager can change persons already assigned tasks or add a person. For this change or addition, the project manager adds or deletes a check mark in the “select” column on the search result table, and clicks on the “enter” button. When there is only one candidate, the project manager simply clicks on the “enter” button, and as a result, the acceptance unit 110 of the personnel assignment system 10 accepts the personnel selection (step 755). When the personnel selection has been established, the “Status” data in the detail table in FIG. 11 is changed from “Assigned” to “Approved”. See also the “Designer” task record to which “Yamazaki” is assigned.

To reject an assigned person, the project manager clicks on the “reject” button on the search result table. In this case, the “Status” data in the detail table is not changed, and the “approve” button in the lower portion of the screen cannot be clicked on.

When the personnel assignments to all the tasks have been established (Yes at step 760), or when only one task to be assigned is on the list (No at step 750), the project manager determines whether the assigned persons should be approved (step 765). To indicate approval, the project manager clicks on the “approve” button in the lower portion of the screen in FIG. 11 (Yes at step 765). In the personnel assignment system 10, the assignment controller 160 automatically reflects the approved personnel data to the project management database 22 of the PM system 20 (step 770) and terminates the processing. To indicate rejection of the personnel assignment, the project manager clicks on the “renotify” button in the lower portion of the screen in FIG. 11 (No at step 765). Then, the notification unit 130 notifies the resource manager of the occurrence of this event, and the personnel assignment system 10 resumes the processing, beginning at step 715. As is described above, even when there is only one task for which the project manager rejects a personnel assignment, the “approve” button can not be clicked on. Therefore, in this case also, the “renotify” button is depressed and the processing is repeated.

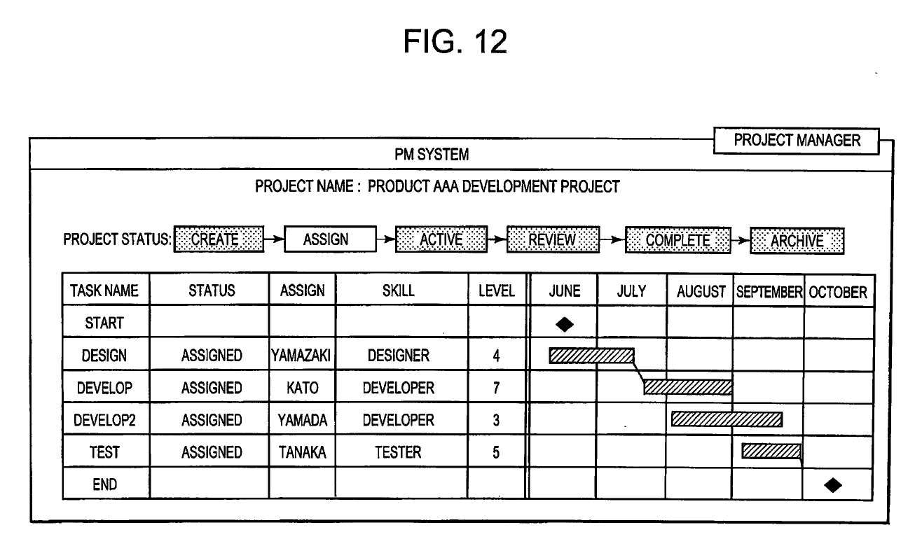

FIG. 12 is a diagram showing an exemplary image of the screen of the PM system 20 after the personnel assignment has been approved. As is apparent from a comparison of the current screen with the screen in FIG. 9, the “Status” data is updated from “NotAssigned” to “Assigned”, and the names of assigned persons are displayed in the “Assign” columns.

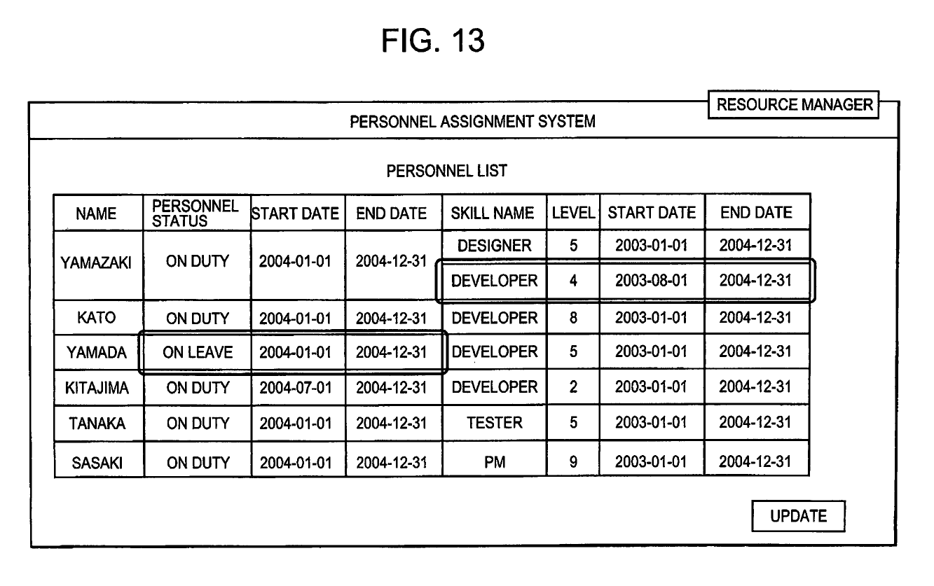

FIG. 8 is a flowchart showing the processing performed by the personnel assignment system 10 when a personnel requirement event has occurred. This processing will now be described with reference to FIGS. 8 and 13 through 16. FIGS. 13 to 16 are exemplary screens that appear after a personnel assignment has been approved on the screen in FIG. 12.

In the personnel assignment system 10, the acceptance unit 110 accepts a change request for personnel data from the RM system 30 (step 810). Specifically, the change request is generated when the resource manager accesses the RM system 30 and enters the contents for personnel requirements (contents for updating). The changes in the personnel data include the addition or deletion of a person and the addition, changing, and deletion of data related to skills and status. Such personnel data changes can be performed not only by the resource manager, but also, for example, by another department head, such as the person in charge of the personnel department, or by a person assigned the task or the chief to whom the pertinent person submits a report.

FIG. 13 is a diagram showing an exemplary image for the screen of the RM system 30 for the entry of personnel requirements. This example shows data for six persons. Processing for this embodiment will be described by employing, as indicated by the highlighting in FIG. 13, a scenario (1) for adding “developer” (level 4) as the skill for “Yamazaki”, and (2) for changing the status of “Yamada” from “on duty” to “on leave”. The resource manager or another data editor enters personnel requirements (1) and (2) in the screen editing mode, and clicks on the “update” button in the lower portion of the screen. Then, the request to change the personnel data is written as event data in the event table 36. Since the personnel assignment system 10 (acceptance unit 10) performs periodical polling for the event table 36, the change request is accepted by the personnel assignment system 10.

As shown in FIG. 8, when the personnel data change request has been accepted, the task determination unit 120 determines whether there is a task that has already been assigned to a person to be altered and that will be affected by the change in the personnel data (step 812). That is, the task determination unit 120 employs the personnel ID data as a key to determine whether there are related task data in the project management database 22 of the PM system 20. When no previously assigned task is present, or when an assigned task will not be affected by changing the personnel data, the personnel assignment system 10 terminates the processing (No at step 812). The case in which there is only a task that will not be affected by changing the personnel data includes a case in which the requirements for the already assigned task are satisfied, even though a skill is added or changed or a skill level is changed (e.g., only a new skill is added, while the skill required for the assigned task is maintained), and a case in which the execution period for a task does not overlap the execution period for the already assigned task, even though the status is changed (e.g., the status is changed to “on leave” for a period from Aug. 10 to 14, 2004, and the task start date is Sep. 1, 2004). Therefore, for the requirement (1), there is no related task (No at step 812), while for the requirement (2), there is a related task (Yes at step 812).

When there is a related task, the assignment controller 160 creates the personnel requirement event records 160 for the individual tasks, and obtains necessary data from the project management database 22 and the personnel management database 32. Data is written in the “owner” field to permit the resource manager to access the personnel assignment system 10. When the resource manager accesses the personnel assignment system 10, the notification unit 130 notifies the resource manager of the presence of this event (step 815). Then, the display controller 150 displays, on the user terminal 50 of the resource manager, information concerning the task assigned to the pertinent person.

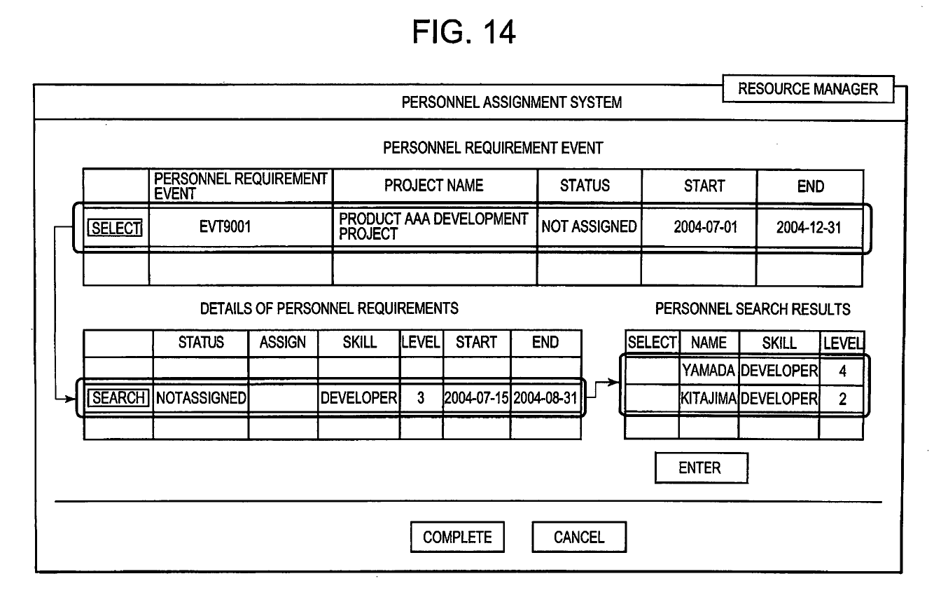

FIG. 14 is a diagram showing an exemplary image for the screen when the resource manager accesses the personnel assignment system 10 and one event (EVT9001) is present thereon. When the resource manager clicks on the “select” button for “EVT9001”, a table related to the details for the corresponding personnel requirement is displayed. In this example, one personnel requirement is present. When the resource manager clicks on the “search” button for a specific task (developer skill: 3), the acceptance unit 110 accepts a request to search for a person available as a replacement (step 820).

In response to the search request, the search unit 140 examines the personnel management database 32 of the RM system 30 and obtains a replacement candidate that matches the search condition (step 825). Specifically, the search unit 140 compares the contents and the skill level and the task execution period that are included in the search condition with the data in the personnel skill record 340, and designates a candidate for the replacement that completely or approximately matches the search condition. When no person who completely satisfies the search condition can be found, the permissible range for determining a candidate “available to be assigned” may be arbitrarily designated. Further, the “status” data in the personnel record 320 is also confirmed, and thereafter, the personnel data, such as the ID, the name and the skill, are obtained for the replacement candidate to be assigned. When there are a plurality of replacement candidates to be assigned, a list comprising a plurality of sets of personnel data is obtained.

The search unit 140 also searches the project management database 22 of the PM system 20 using, as a key, the ID of the replacement candidate, and obtains data (especially period data) related to the task that was already assigned to the candidate (step 828). Such data are required because when the execution period for the task already assigned to the replacement candidate overlaps the execution period for a new task to be assigned, assigning the new task to the candidate is not practical. For this determination, the search unit 140 not only examines the data in the RM system 30 but also in the PM system 20.

The display controller 150 displays, on a screen, a table of data for replacement candidates available for the assignment (step 830). In FIG. 14, example search results are displayed, and two persons are shown as candidates. “Yarnazaki” is a person for whom the skill has been added in accordance with the requirement above, and at the task requirement event, has already been assigned a task as a “designer” (see, for example, FIG. 12). However, since the execution periods for the assigned tasks do not overlap, “Yamazaki” is listed as a candidate available for assignment. The resource manager may only enter a check mark in the “select” column to select a desired person from the list. In this case, a plurality of persons can be selected as candidates for assignment. Since the level of the required skill is “3”, it is most appropriate that “Yamazaki”, who has the highest skill level, be selected. Then, when the resource manager selects a specific person (for example, “Yamazaki”) and clicks on the “enter” button, the acceptance unit 110 of the personnel assignment system 10 accepts the selection of the candidate (step 835). In response to the establishment of the selected personnel, the “Status” data in the detail table for personnel requirements in FIG. 14 is changed from “NotAssigned” to “Assigned”.

When there are other tasks to which personnel should be assigned (No at step 840), the assignment controller 160 waits for the next search request to be issued by the resource manager (the personnel assignment system 10 is in the waiting state). When the resource manager has assigned personnel to all the tasks and clicks on the “complete” button in the lower portion of the screen (Yes at step 840), the notification unit 130 notifies the project manager that the assignment of personnel to the project or to the tasks has been completed (step 845).

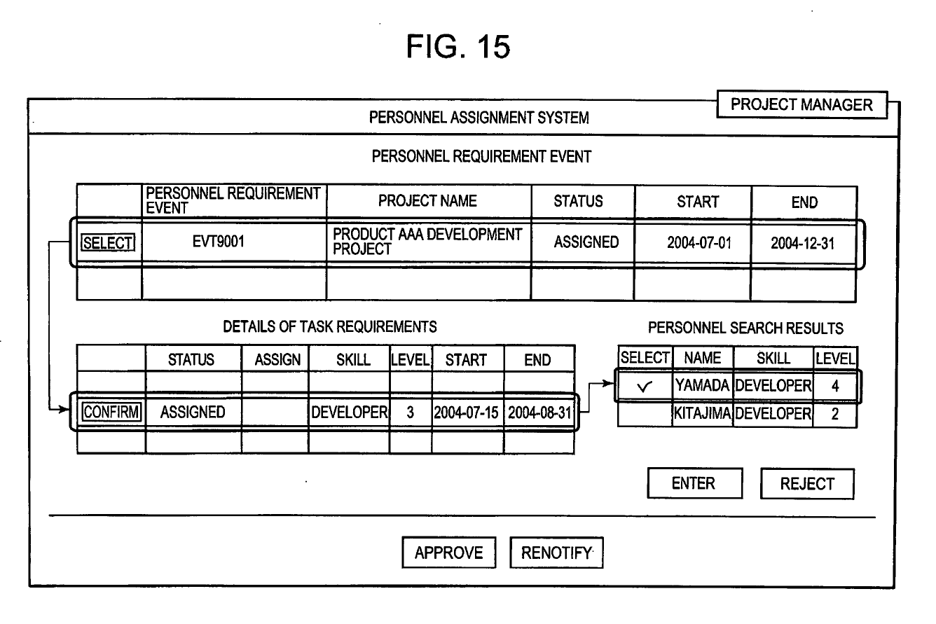

FIG. 15 is a diagram showing an exemplary image of the screen when the project manager accesses the personnel assignment system 10. As is apparent from FIG. 15, the structure of the screen is similar to that in FIG. 14. The detail table, for example, can also be displayed by selecting a specific personnel requirement. A difference between the screen in FIG. 15 and the screen in FIG. 14 is that the search for candidates to be assigned (and reassigned) has already been completed. Therefore, the project manager need not execute a search request. Instead of the “search” button, a “confirm” button is prepared in the leftmost column of the detail table. When the project manager clicks on the “confirm” button, the list of corresponding candidates to be assigned is displayed. When a plurality of tasks (personnel requirements) are present on the list (Yes at step 850), the project manager must confirm and establish a personnel assignment for all the tasks (personnel requirements) (No at step 860).

When a plurality of candidates are available for the assignment, the project manager can change an assigned person, or can add a person. For the changing or the addition of a person, the project manager enters or deletes a check mark in the “select” column of the search result table, and clicks on the “enter” button. When there is only one candidate, the project manager simply clicks on the “enter” button. Then, the acceptance unit 10 of the personnel assignment system 10 accepts the selection of the personnel (step 855), and in response to the establishment of the personnel selection, the “Status” data in the detail table in FIG. 15 is changed from “Assigned” to “Approved”.

For the rejection of an assigned person, the project manager clicks on the “reject” button on the search result table. At this time, the “approve” button in the lower portion of the screen can not be clicked on.

When personnel assignments to all the tasks (personnel requirements) have been established (Yes at step 860), or when only one task (personnel requirement) is present on the list (No at step 850), the project manager is asked to determine whether the assigned personnel should be approved (step 865). For an approval, the project manager clicks on the “approve” button in the lower portion of the screen in FIG. 15 (Yes at step 865). In the personnel assignment system 10, the assignment controller 160 automatically reflects the approved personnel data to the project management database 22 of the PM system 20 (step 870). For a rejection of the assigned personnel, the project manager clicks on the “renotify” button in the lower portion of the screen in FIG. 15 (No at step 865). Thus, the notification unit 130 again notifies the resource manager of the event, and the personnel assignment system 10 resumes the processing, beginning at step 815. As is described above, when the project manager rejects a personnel assignment, even for only one task (personnel requirement), the “approve” button cannot be clicked on. Therefore, in this case also, the “renotify” button is depressed and the same processing is repeated.

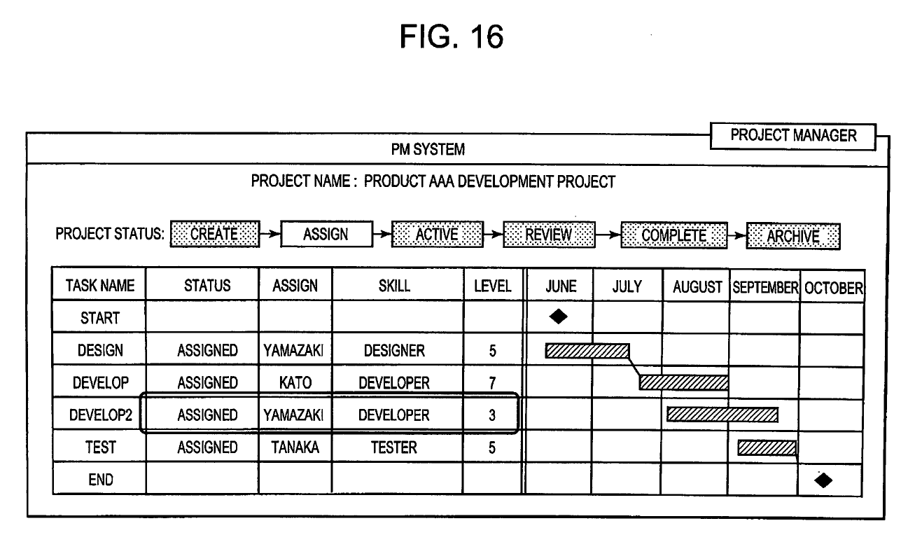

FIG. 16 is a diagram showing an exemplary image for the screen of the PM system 20 after the personnel assignment has been approved. By comparing the screen in FIG. 16 with the screen FIG. 12, it is apparent that, as indicated by the “Assign” column, the person in charge of task “Develop2” is changed from “Yamada” to “Yamazaki”.

A system according to the present invention encompasses a project management system for managing task data related to a plurality of tasks constituting a project, and as a personnel assignment system that is connected to a personnel management system for managing personnel data. Information related to tasks already assigned to personnel is stored in advance as task data in the project management system, and at the least, identification data for the assigned personnel are correlated with the task data. Since the identification data are also included in personnel data stored in the personnel management system, the identification data can be employed as key information for a record search. Therefore, when personnel data are changed, the personnel assignment system of the invention automatically extracts, from the identification data, related tasks that have already been assigned, and can automatically reassign replacement personnel by referring to the assigned tasks.

In the above described embodiment, for the assignment of personnel to a task, the resource manager performs a preliminary personnel search and selection (temporary assignment), and the project manager approves the contents, so that the assigned contents are established. However, in another embodiment, the project manager may directly perform the preliminary personnel search and selection. In this case, at step 715 in FIG. 7 and step 815 in FIG. 8, the project manager is notified of the event, and performs the succeeding operation. The processing following the coupling points A (FIG. 7) and B (FIG. 8) is connected to the block 765 in FIG. 7 and the block 865 in FIG. 8.

Furthermore, in the above embodiment, when there are a plurality of candidates for assignment, all the candidates can also be presented to the project manager to change the personnel. However, the personnel selection by the resource manager may be fixed and the project manager may be inhibited from selecting another candidate.

Further, in the above embodiment, the user terminal 40 of the project manager and the user terminal 50 of the resource manager may be connected to the personnel assignment system 10 via the network 60. However, the project manager or the resource manager may directly operate the personnel assignment system 10, as well.

We claim:

1. In a computer connected to a first system for managing project task data and to a second system for managing personnel data including identification data, a method of assigning personnel to tasks, comprising:
searching the second system in response to a request for assigning personnel to at least one task from the first system, assigning at least one person satisfying requirements of the at least one task by searching the second system, and storing identification data of the at least one assigned person, in association with the task data, into the first system;
accepting a change of personnel data of a specific person from the second system;
determining whether at least one related task is assigned to the specific person by referring to the task data of the first system using identification data of the specific person as a key in response to accepting the change;
if there is the at least one related task, storing task data of the related task in an event database and displaying the task data of the related task on a display unit;
accepting a search request of a replacement for the related task;
searching the second system to find a replacement candidate who can be assigned to the related task and acquiring personnel data of the replacement candidate, in response to the search request for the replacement;
displaying a list of replacement candidates who can be assigned to the related task on the display unit;
accepting a replacement selection from the list; and
assigning the selected replacement to the related task and storing personnel data of the replacement into the event database, in response to the selection of the replacement.

2. The method according to claim 1, wherein the task data includes data on a task execution period.

3. The method according to claim 2, further comprising: determining whether at least one assigned task is already assigned to the replacement candidate by referring to the task data of the first system using identification data of the replacement candidate as a key, and, if there is the assigned task, acquiring task data of the assigned task, after acquiring the personnel data of the candidate for the replacement, wherein the list of replacement candidates who can be assigned to the related task includes only replacement candidates whose period data of the related task does not overlap with that of the assigned task.

4. The method according to claim 1, further comprising: storing identification data of the replacement associated with the task data of the related task into the first system.

5. The method according to claim 1, wherein the display unit is a display of a first user terminal used by a resource manager, in response to an approval of a project manager for the assignment of the replacement.

6. The method according to claim 5, further comprising: notifying a project manager that a replacement has been assigned to the related task and displaying data included in the event database on a second user terminal used by the project manager.

7. The method according to claim 6, further comprising: storing identification data of the replacement associated with the task data of the related task into the first system, in response to an approval of the project manager for the assignment of the replacement.

8. The method according to claim 1, wherein the display unit is a display of a user terminal for a project manager.

9. A computer program product for assigning personnel to tasks, suitable for use with a computer connected to a first system for managing project task data and to a second system for managing personnel data including identification data, the computer program product comprising a computer readable medium having computer readable program code embedded therein, the computer readable program code comprising:
computer readable program code for searching the second system in response to a request for assigning personnel to at least one task from the first system, assigning at least one person satisfying requirements of the at least one task by searching the second system, and storing identification data of the at least one assigned person, in association with the task data, into the first system;
computer readable program code for accepting a change of personnel data of a specific person from the second system;
computer readable program code for determining whether at least one related task is assigned to the specific person by referring to the task data of the first system using identification data of the specific person as a key in response to the acceptance of the change;
computer readable program code for storing, if there is the at least one related task, task data of the related task in an event database and displaying the task data of the related task on a display unit;
computer readable program code for accepting a search request of a replacement for the related task;
computer readable program code for searching the second system to find a replacement candidate who can be assigned to the related task and acquiring personnel data of the replacement candidate, in response to the search request for the replacement;
computer readable program code for displaying a list of replacement candidates who can be assigned to the related task on the display unit;
computer readable program code for accepting a replacement selection from the list; and
computer readable program code for assigning the selected replacement to the related task and storing personnel data of the replacement into the event database, in response to the selection of the replacement.

10. The computer program product according to claim 9, wherein the task data includes data on a task execution period.

11. The computer program product according to claim 10, further comprising computer readable program code for determining whether at least one assigned task is already assigned to the replacement candidate by referring to the task data of the first system using identification data of the replacement candidate as a key, and, if there is the assigned task, acquiring task data of the assigned task, after acquiring the personnel data of the candidate for the replacement, wherein the list of replacement candidates who can be assigned to the related task includes only replacement candidates whose period data of the related task does not overlap with that of the assigned task.

12. The computer program product according to claim 9, further comprising computer readable program code for storing identification data of the replacement associated with the task data of the related task into the first system.

13. The computer program product according to claim 9, wherein the display unit is a display of a first user terminal used by a resource manager, in response to an approval of a project manager for the assignment of the replacement.

14. The computer program product according to claim 13, further comprising computer readable program code for notifying a project manager that a replacement has been assigned to the related task and displaying data included in the event database on a second user terminal used by the project manager.

15. The computer program product according to claim 14, further comprising computer readable program code for storing identification data of the replacement associated with the task data of the related task into the first system, in response to an approval of the project manager for the assignment of the replacement.

16. The computer program product according to claim 9, wherein the display unit is a display of a user terminal for a project manager.

17. A computer for assigning personnel to tasks, connected through a network to a first system for managing project task data that includes identification data for personnel already assigned to corresponding tasks, and to a second system for managing personnel data, including identification data, comprising:
an acceptance unit for accepting an event, a request, or an instruction from the first system, the second system or another user terminal;
a determination unit for, when the acceptance unit has accepted, from the second system, an entry for changing personnel data for a specific person, examining task data stored in the first system by using identification data for the specific person as a key to determine whether there is at least one related task assigned to the specific person;
an assignment controller for, when there is at least one related task, obtaining task data for the related task and storing the task data in an event database;
a display controller for displaying, on a display unit, data stored in the event database; and
a search unit for, when the acceptance unit has accepted a search request to find a person for replacement of the related task, examining the second system to find a candidate for the replacement that can be assigned to the related task, and obtaining personnel data for the candidate for the replacement,
wherein, when the display controller displays a list of candidates for the replacement on the display unit, and when the acceptance unit accepts a replacement person selected from the list, the assignment controller assigns the selected replacement person to the related task and stores personnel data for the selected replacement person in the event data.

18. A computer according to claim 17, wherein the task data includes period data for a task execution period; wherein, after the personnel data for the candidate for the replacement has been obtained, the search unit refers to the task data in the first system while using identification data for the candidate for the replacement as a key to determine whether at least one task is already assigned to the candidate for the replacement, and if there is an assigned task, acquires task data for the assigned task; and wherein the list of the candidates for the replacement who can be assigned to the related task includes only candidates for the replacement for whom period data for the related task does not overlap that of the assigned task.

19. The computer according to claim 17, wherein, in response to an approval by a project manager of the assignment of the replacement, the assignment controller stores, in the first system, identification data for the replacement associated with the task data for the related task.

20. The computer according to claim 17, wherein the display unit is a display for a first user terminal used by a resource manager, and the display controller displays data stored in the event database on a second user terminal used by the project manager.
